(19) United States
(12) Patent Application Publication
(10) Pub. No.: US 2026/0140367 A1
(43) Pub. Date: May 21, 2026

(54) VIBRATING DEVICE AND IMAGE PICKUP DEVICE

(71) Applicant: Murata Manufacturing Co., Ltd., Nagaokakyo-shi (JP)

(72) Inventors: Yuuki ISHII, Nagaokakyo-shi (JP); Hitoshi SAKAGUCHI, Nagaokakyo-shi (JP); Noritaka KISHI, Nagaokakyo-shi (JP); Akihiro HIRAKA, Nagaokakyo-shi (JP)

(21) Appl. No.: 19/449,644

(22) Filed: Jan. 15, 2026

Related U.S. Application Data
(63) Continuation of application No. PCT/JP2024/016936, filed on May 7, 2024.

(30) Foreign Application Priority Data
Aug. 1, 2023 (JP) 2023-125403

(51) Int. Cl. G02B 27/00; B06B 1/06; G02B 7/02; G03B 17/12; G03B 30/00

(52) U.S. Cl. CPC G02B 27/0006; B06B 1/06; G02B 7/021; G03B 17/12; G03B 30/00

(57) ABSTRACT

A vibrating device that includes: a light-transparent body; a tubular vibrator in contact with the light-transparent body and constructed to vibrate the light-transparent body, the tubular vibrator including: a first tube portion that is in contact with the light-transparent body, a second tube portion, a spring portion that connects the first tube portion and the second tube portion to each other and that has a curved cross-sectional shape in a plane parallel to the axial direction of the tubular shape, and an unbalancing member that generates unbalanced vibrations of the light-transparent body; a piezoelectric device connected to the second tube portion of the vibrator; and a housing that holds the light-transparent body and that covers the vibrator.

### CROSS REFERENCE TO RELATED APPLICATIONS

The present application is a continuation of International application No. PCT/JP2024/016936, filed May 7, 2024, which claims priority to Japanese Patent Application No. 2023-125403, filed Aug. 1, 2023, the entire contents of each of which are incorporated herein by reference.

### TECHNICAL FIELD

The present disclosure relates to a vibrating device and an image pickup device.

### BACKGROUND ART

In recent years, a vehicle includes an image pickup device installed at a vehicle front or rear to control a safety device or driving support using images obtained by the image pickup device. Such an image pickup device is usually disposed outside the vehicle. Thus, foreign matter such as raindrops (waterdrops), mud, or dust may adhere to a light-transparent body (a protective cover or a lens) covering the exterior of the image pickup device.

When foreign matter adheres to the light-transparent body, the image pickup device captures an image including the foreign matter, and fails to obtain a clear image. An image pickup device described in Japanese Unexamined Patent Application Publication No. 2017-170303 (Patent Document 1) includes a droplet removal device (vibrating device) that vibrates a light-transparent body to remove foreign matter adhering to the surface of the light-transparent body.

Patent Document 1: Japanese Unexamined Patent Application Publication No. 2017-170303

### SUMMARY OF THE DISCLOSURE

To remove foreign matter adhering to the surface of the light-transparent body by vibrating the light-transparent body, the vibrating device collects the foreign matter at a position of the light-transparent body that is to be displaced at the maximum, and atomizes the collected foreign matter with vibrations for removal. However, when foreign matter with high viscosity and incapable of being atomized adheres to the surface of the light-transparent body, the foreign matter is simply collected at the center portion of the light-transparent body without being atomized, and the collected foreign matter blocks the view. Although a method for removing foreign matter by vibrating a light-transparent body and atomizing the foreign matter using the vibrating device is effective, another method for removing foreign matter adhering to the surface of the light-transparent body other than atomization is to be added.

Thus, the present disclosure aims to provide a vibrating device and an image pickup device capable of removing foreign matter adhering to the surface of a light-transparent body with a method other than atomization.

A vibrating device according to an aspect of the present disclosure includes: a light-transparent body; a tubular vibrator in contact with the light-transparent body and constructed to vibrate the light-transparent body, the tubular vibrator including: a first tube portion that is in contact with the light-transparent body, a second tube portion, a spring portion that connects the first tube portion and the second tube portion to each other and that has a curved cross-sectional shape in a plane parallel to the axial direction of the tubular shape, and an unbalancing member that generates unbalanced vibrations of the light-transparent body; a piezoelectric device connected to the second tube portion of the vibrator; and a housing that holds the light-transparent body and that covers the vibrator.

An image pickup device according to an aspect of the present disclosure includes the vibrating device described above, and an image pickup element disposed in a direction of a field of view with the light-transparent body.

According to the present disclosure, a vibrating device includes an unbalancing member that generates unbalanced vibrations of the light-transparent body, and thus can remove foreign matter adhering to the surface of the light-transparent body with a method other than atomization.

### BRIEF DESCRIPTION OF THE DRAWINGS

FIG. 1 is a cross-sectional view of an image pickup device according to an embodiment.

FIG. 2 is a perspective view of a structure of a vibrating device according to an embodiment.

FIG. 3 is a perspective view illustrating displacement caused in a vibrating device according to an embodiment.

FIG. 4 is a cross-sectional view illustrating displacement caused in a vibrating device according to an embodiment.

FIG. 5 is a cross-sectional view of an image pickup device according to a first modification example.

FIG. 6 is a perspective view of a structure of a vibrating device according to a second modification example.

FIG. 7 is a perspective view of a structure of a vibrating device according to a third modification example.

### DESCRIPTION OF THE PREFERRED EMBODIMENTS

With reference to the drawings, an image pickup device according to one or more embodiments is described below in detail. Throughout the drawings, the same reference signs denote the same or corresponding components. The image pickup device described below is usable as, for example, a vehicle-mounted image pickup device, and can vibrate a light-transparent body (such as an outermost-layer lens) to remove foreign matter adhering to the surface of the light-transparent body. The purpose of the image pickup device is not limited to use as a vehicle-mounted image pickup device. For example, the image pickup device is also applicable to a surveillance camera for security, or an image pickup device mounted on a drone.

### EMBODIMENTS

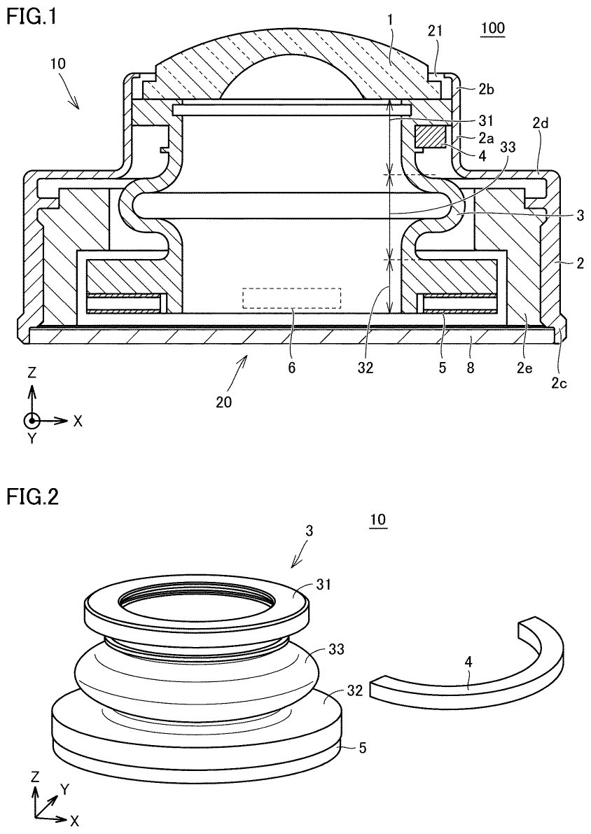

FIG. 1 is a sectional view of an image pickup device 100 according to an embodiment. FIG. 2 is a perspective view of a vibrating device 10 according to an embodiment. An X-direction, a Y-direction, and a Z-direction in the drawings respectively denote the lateral direction, the depth direction, and the height direction of the image pickup device 100. The image pickup device 100 includes the vibrating device 10 and a sensor device 20. The vibrating device 10 includes an outermost-layer lens 1, a housing 2, a vibrator 3, and a piezoelectric device 5. The sensor device 20 includes a bracket 8 that holds an image pickup element 6. Although not illustrated, the image pickup device 100 preferably includes an inner-layer lens between the outermost-layer lens 1 and the image pickup element 6.

After the alignment between the outermost-layer lens 1 and the image pickup element 6 is adjusted, the sensor device 20 is joined to the vibrating device 10 to form the image pickup device 100. The image pickup element 6 is an image sensor such as a charge coupled device (CCD) or a complementary metal-oxide-semiconductor (CMOS) sensor, and mounted on a circuit board (not illustrated). The circuit board may receive not only a semiconductor device that controls the image pickup element 6, such as a general-purpose integrated circuit (IC) or an application specific integrated circuit (ASIC), but also a semiconductor device that generates signals to drive the piezoelectric device 5. The circuit board is fixed to the bracket 8 at a position where the alignment between the circuit board and the outermost-layer lens 1, the inner-layer lens (not illustrated), and the image pickup element 6 is adjusted. The bracket 8 is formed from, for example, aluminum (A5052).

The outermost-layer lens 1 is a light-transparent body that is transparent to light of a predetermined wavelength (for example, a wavelength of visible light or a wavelength capturable by an image pickup element), for example, borosilicate-crown glass (BK7), fused quarts, crown glass, flint glass, or a convex meniscus lens. The vibrating device 10 may include a transparent member such as a protective cover instead of the outermost-layer lens 1. The protective cover is formed from glass or resin such as transparent plastics.

The end portion of the outermost-layer lens 1 is held at an end portion 2b of a tubular first portion 2a extending in the Z-direction. The end portion 2b of the first portion 2a is in contact with the outermost-layer lens 1 with a retainer 21 interposed therebetween. The retainer 21 may be formed from a resin such as polyphenylenesulfide (PPS) or a metal such as stainless steel (SUS304, SUS420, or SUS440). The end portion 2b of the first portion 2a, the retainer 21, the outermost-layer lens 1, and the vibrator 3 are bonded together with, for example, an adhesive. In FIG. 1, the housing 2 indirectly holds the outermost-layer lens 1 with the retainer 21 interposed in between, but may directly hold the outermost-layer lens 1 at the end portion 2b of the first portion 2a.

The housing 2 includes a first portion 2a, a tubular second portion 2c having a larger diameter than the first portion 2a, and a third portion 2d that connects the first portion 2a and the second portion 2c to each other. The third portion 2d has a disc shape extending in the radial direction of the first portion 2a (X and Y directions). The housing 2 has a shape of two tubes with different diameters (the first portion 2a and the second portion 2c) connected with a disc (the third portion 2d).

The first portion 2a has a shape extending in the axial direction (Z-direction) of the tube, and thus, can reduce vibrations in the radial direction (X and Y directions) of the tube by being elastically deformed like a spring in the radial direction (X and Y directions) of the tube, as described below. The second portion 2c includes a weight 2e to reduce vibrations from the vibrator 3. In addition, in the housing 2, the first portion 2a, the end portion 2b, the second portion 2c, the third portion 2d, and the weight 2e may be formed integrally with or separately from one another. The housing 2 is formed from, for example, stainless steel (SUS304, SUS420, or SUS440).

As illustrated in FIG. 1, the vibrating device 10 includes the vibrator 3 that is in contact with the outermost-layer lens 1 to vibrate the outermost-layer lens 1. The vibrator 3 is tubular, and includes a first tube portion 31 that is in contact with the outermost-layer lens 1, a second tube portion 32 at which the piezoelectric device 5 is disposed, and a spring portion 33 that connects the first tube portion 31 and the second tube portion 32 to each other. The spring portion 33 has an S-shaped cross section. Although not illustrated, an inner-layer lens may be disposed inside the vibrator 3. The vibrator 3 is formed from, for example, stainless steel (SUS304, SUS420, or SUS440).

The first tube portion 31 transmits vibrations of the vibrator 3 to the outermost-layer lens 1 while allowing the end portion 2b of a cylindrical portion, extending in the axial direction (Z-direction) of the tube, to be in contact with the rim of the outermost-layer lens 1. The first tube portion 31 has the end portion 2b extending in the radial direction (X and Y directions) of the tube to stably hold the outermost-layer lens 1.

The second tube portion 32 is a portion that vibrates together with the vibrations of the piezoelectric device 5, and has a larger thickness than the first tube portion 31 and the spring portion 33. This structure can more efficiently transmit the vibrations of the piezoelectric device 5 to the outermost-layer lens 1.

The spring portion 33 is a portion that supports the first tube portion 31 and transmits the vibrations of the second tube portion 32 to the first tube portion 31. The first tube portion 31, the second tube portion 32, and the spring portion 33 may be formed integrally with or separately from one another. Although, in the above description, the spring portion 33 has an S-shaped cross section, the spring portion 33 may have any curved shape (for example, a shape of two continuous Ss) capable of transmitting the vibrations of the second tube portion 32 to the first tube portion 31.

The image pickup device 100 may be attached to a device (such as a vehicle) while having the axial direction (Z-direction) of the tube oriented at approximately 90 degrees with respect to the direction of gravity. In such a case, foreign matter (such as raindrops) may flow through a gap between the outermost-layer lens 1 and the housing 2, and may adhere to the vibrator 3. When adhering to the vibrator 3, the foreign matter attenuates the vibrations of the vibrator 3 and lowers the vibrating performance of the vibrating device 10. Thus, the vibrating device 10 including the spring portion 33 having a curved cross-sectional shape facilitates movement of the incoming foreign matter along the curvature of the curved shape, and sliding of the foreign matter off the vibrator 3 with its weight. Particularly preferably, the spring portion 33 has a shape protruding in the radial direction of the first tube portion with respect to the first tube portion 31 and the second tube portion 32. The vibrating device 10 with this structure allows the incoming foreign matter to move along the curvature of the spring portion 33 in the direction of gravity, and to slide off the vibrator 3 with its weight.

The piezoelectric device 5 is disposed at the surface of the second tube portion 32 opposite to the surface that is in contact with the outermost-layer lens 1. The piezoelectric device 5 is hollow, and vibrates, for example, when being polarized in a thickness direction. The piezoelectric device 5 is formed from lead zirconate titanate (PZT) piezoelectric ceramics. Alternatively, other piezoelectric ceramics such as (K, Na) NbO₃ piezoelectric ceramics may be used. Alternatively, piezoelectric single crystals such as LiTaO₃ may be used.

When the hollow circular piezoelectric device 5 vibrates in the radial direction and the vibrations are transformed by the spring portion 33 of the vibrator 3 into the vibrations in the Z-direction (vertical direction in the drawing), the outermost-layer lens 1 vibrates in the Z-direction. The vibrating device 10 vibrates the outermost-layer lens 1 in the Z-direction. When the vibrating device 10 vibrates the outermost-layer lens 1 to allow the center portion to be displaced at the maximum, the vibrating device 10 removes foreign matter adhering to the surface of the outermost-layer lens 1 by moving the foreign matter to the center portion of the outermost-layer lens 1 and atomizing the foreign matter. However, the vibrating device 10 fails to remove, for example, foreign matter with high viscosity by simply moving the foreign matter to the center portion of the outermost-layer lens 1 and atomizing the foreign matter for removal. Thus, instead of atomizing foreign matter for removal, the vibrating device 10 generates unbalanced vibrations of the outermost-layer lens 1 to allow the adhering foreign matter to slide off the outermost-layer lens 1 for removal.

The vibrating device 10 includes an unbalancing member that adds a mass to at least a part of the vibrator 3 to generate unbalanced vibrations of the outermost-layer lens 1. More specifically, as illustrated in FIG. 1, the vibrating device 10 includes a weight 4 at the first tube portion 31. The weight 4 is disposed only partially, instead of around the entire circumference of the first tube portion 31. As illustrated in FIG. 2, the weight 4 has a semicircular shape that extends around half the circumference of the first tube portion 31.

The weight 4 may be formed from any material as long as it can add a mass to a part of the first tube portion 31, and may be formed from the same material as or a different material from, for example, the first tube portion 31. When the specific gravity of the material of the weight 4 is greater than the specific gravity of the material of the first tube portion 31, the size of the weight 4 can be reduced, and the space for receiving the weight 4 can be saved. The weight 4 may include multiple pieces, or may be integrated with or formed separately from the first tube portion 31.

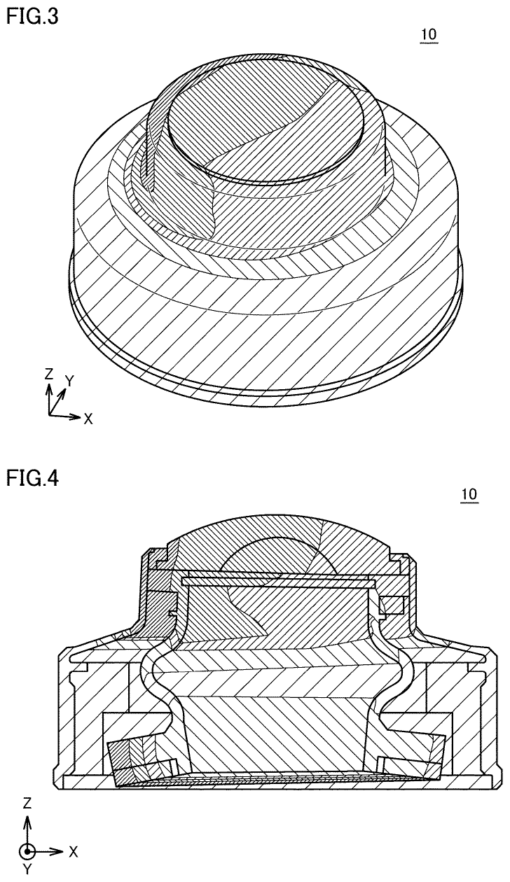

When vibrating the outermost-layer lens 1 in the Z-direction, the vibrating device 10 including the weight 4 disposed at a part of the first tube portion 31 can generate unbalanced vibrations of the outermost-layer lens 1 by differently displacing the portion to which the weight 4 is disposed and a portion to which the weight 4 is not disposed. FIG. 3 is a perspective view illustrating displacement caused in the vibrating device 10 according to an embodiment. FIG. 4 is a cross-sectional view illustrating displacement caused in the vibrating device 10 according to an embodiment. FIG. 3 and FIG. 4 illustrate a simulation result obtained by vibrating the outermost-layer lens 1 with an application of a voltage to the piezoelectric device 5 in the vibrating device 10. In FIG. 3 and FIG. 4, variable density of hatching indicates the amount of displacement, and the portion with thicker hatching indicates a portion with larger displacement. In the vibrating device 10 illustrated in FIG. 3 and FIG. 4, a portion that is displaced at the maximum is displaced by approximately 8 μm.

As is clear from FIG. 3 and FIG. 4, in the vibrating device 10, the outermost-layer lens 1 and the first tube portion 31 are largely displaced. More specifically, portions of the outermost-layer lens 1 and the first tube portion 31 on the side (left side) on which the weight 4 is not disposed are displaced more than the portions of the outermost-layer lens 1 and the first tube portion 31 on the side (right side) on which the weight 4 is disposed. The vibrating device 10 thus tilts and vibrates the outermost-layer lens 1 while raising or lowering the side on which the weight 4 is not disposed more than the side on which the weight 4 is disposed. When the outermost-layer lens 1 is vibrated while being tilted, the vibrating device 10 can remove the adhering foreign matter by allowing the foreign matter to slide off the outermost-layer lens 1. Preferably, a water-repellent or hydrophilic coating material is applied to the surface of the outermost-layer lens 1.

As is clear from FIG. 3 and FIG. 4, the vibrating device 10 vibrates the outermost-layer lens 1 by elastically deforming the first portion 2a and the third portion 2d of the housing 2 like a spring, and thus reduces leakage of the vibrations to the second portion 2c of the housing 2. Particularly, the first portion 2a of the housing 2 is elastically deformed like a spring to absorb displacement in the X-direction caused by tilting and vibrating of the outermost-layer lens 1, and leakage of vibrations to the second portion 2c of the housing 2 is thus reduced. The third portion 2d of the housing 2 is elastically deformed like a spring to absorb displacement in the Z-direction caused by vibrating of the outermost-layer lens 1 in the Z-direction, and leakage of vibrations to the second portion 2c of the housing 2 is thus reduced.

As is clear from FIG. 3 and FIG. 4, regardless of when the outermost-layer lens 1 is vibrated, the second portion 2c of the housing 2 is negligibly displaced and the vibrations of the vibrator 3 are not leaked. Thus, when the second portion 2c of the housing 2 is held by a component of a vehicle, the image pickup device 100 can be attached to the vehicle without allowing the vibrations of the vibrating device 10 to be transmitted to the vehicle. The second portion 2c of the housing 2 receives the weight 2e at the surface facing the vibrator 3, and the weight 2e serves as inertial resistance to reduce the vibrations from the vibrator 3.

### First Modification Example

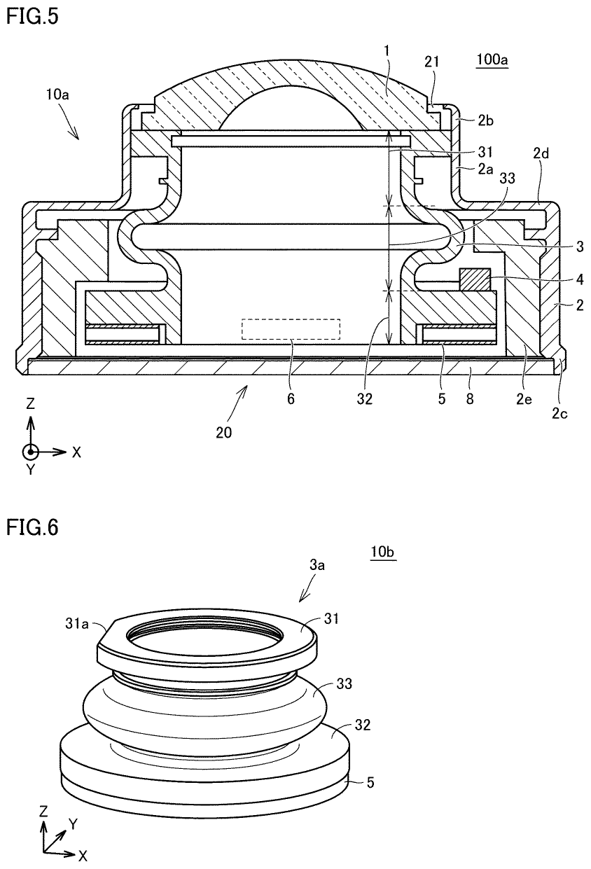

As illustrated in FIG. 1, the vibrating device 10 includes the weight 4 at the first tube portion 31. However, the weight 4 may be located at any position of the vibrator 3 rather than at the first tube portion 31. FIG. 5 is a cross-sectional view of an image pickup device 100a according to a first modification example. In the image pickup device 100a, the same components as those in the image pickup device 100 illustrated in FIG. 1 are denoted with the same reference signs without being described repeatedly.

A vibrating device 10a includes an unbalancing member to add a mass to at least a part of the vibrator 3 to generate unbalanced vibrations of the outermost-layer lens 1. More specifically, as illustrated in FIG. 5, the vibrating device 10a includes the weight 4 at the second tube portion 32. The weight 4 is disposed only partially instead of around the entire periphery of the second tube portion 32, and has, for example, a semicircular shape that extends around half the circumference of the second tube portion 32. When the second tube portion 32 is to receive the weight 4, the second tube portion 32 is to retain a space for receiving the weight 4 not to allow the weight 4 and the weight 2e disposed at the second portion 2c of the housing 2 to interfere with each other. Thus, the space for receiving the weight 2e disposed at the second portion 2c of the housing 2 is reduced.

The material of the weight 4 is not limited to a particular one as long as it can add a mass to a part of the second tube portion 32, and may be the same as or different from the material for, for example, the second tube portion 32. When the material of the weight 4 has a larger specific gravity than the material of the second tube portion 32, the size of the weight 4 can be reduced, and the space for receiving the weight 4 can thus be reduced. The weight 4 may include multiple pieces, or may be integrated with or formed separately from the second tube portion 32.

The position at which the weight 4 is disposed is not limited to the first tube portion 31 and the second tube portion 32, and the weight 4 may be disposed at the spring portion 33. Multiple weights 4 may be disposed at multiple positions, for example, at the first tube portion 31 and the second tube portion 32. In that case, the weights 4 disposed at different positions may have different weights 4. Instead of being disposed at the outer surface (surface facing the housing 2) of the vibrator 3, the weight 4 may be disposed at the inner surface of the vibrator 3.

### Second Modification Example

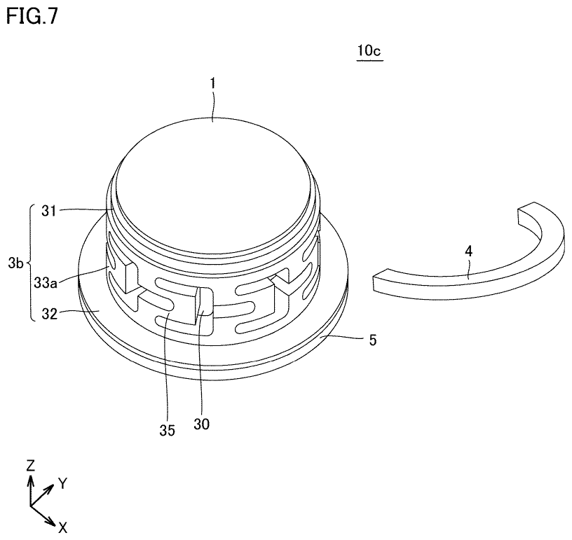

The vibrating device 10 adds a mass to at least a part of the vibrator 3 to serve as an unbalancing member. Alternatively, the unbalancing member may delete a mass from at least a part of the vibrator 3. FIG. 6 is a perspective view of a structure of a vibrating device 10b according to a second modification example. In the vibrating device 10b, the same components as those in the vibrating device 10 illustrated in FIG. 2 are denoted with the same reference signs without being described repeatedly. The components in the vibrating device 10b not illustrated in FIG. 6 are the same as those in the vibrating device 10 illustrated in FIG. 1.

The vibrating device 10b includes a vibrator 3a that is in contact with the outermost-layer lens 1 to vibrate the outermost-layer lens 1. The vibrator 3a is tubular, and includes a first tube portion 31 that in contact with the outermost-layer lens 1, a second tube portion 32 at which the piezoelectric device 5 is disposed, and a spring portion 33 that connects the first tube portion 31 and the second tube portion 32 to each other.

The vibrating device 10b further includes an unbalancing member that deletes a mass from at least a part of the vibrator 3a to generate unbalanced vibrations of the outermost-layer lens 1. More specifically, as illustrated in FIG. 6, the vibrator 3a includes a cut portion 31a formed by cutting a part of the first tube portion 31. The cut portion 31a is formed by cutting a portion of the vibrator 3a at the left in the drawing.

In the first tube portion 31, a portion at which the cut portion 31a is formed (a portion on the left) is lighter than a portion at which the cut portion 31a is not formed (a portion on the right). Thus, the portions of the outermost-layer lens 1 and the first tube portion 31 on the side on which the cut portion 31a is formed are displaced more than the portions of the outermost-layer lens 1 and the first tube portion 31 on the side on which the cut portion 31a is not formed. The vibrating device 10b thus tilts and vibrates the outermost-layer lens 1 while raising or lowering the side on which the cut portion 31a is formed more than the side on which the cut portion 31a is not formed. When the outermost-layer lens 1 is vibrated while being tilted, the vibrating device 10b can remove the adhering foreign matter by allowing the foreign matter to slide off the outermost-layer lens 1.

The position of the cut portion 31a is not limited to the first tube portion 31, and the cut portion 31a may be formed at the second tube portion 32 or the spring portion 33. Alternatively, for example, multiple cut portions 31a may be formed at multiple positions, for example, at the first tube portion 31 and the second tube portion 32. In that case, the cut portions 31a formed at different positions may delete different masses. Instead of being formed at the outer surface (surface facing the housing 2) of the vibrator 3a, the cut portion 31a may be formed at the inner surface of the vibrator 3a. The vibrator 3a may include a combination of a cut portion and a weight, for example, the cut portion may be formed at the first tube portion 31 and the weight may be disposed at the second tube portion 32.

### Third Modification Example

As illustrated in FIG. 1, the vibrating device 10 includes the vibrator 3 including the spring portion 33 with an S-shaped cross section. However, the structure of the vibrator is not limited to a structure including the spring portion 33 with an S-shaped cross section. FIG. 7 is a perspective view of a structure of a vibrating device 10c according to a third modification example. In the vibrating device 10c, the same components as those in the vibrating device 10 illustrated in FIG. 1 are denoted with the same reference signs without being described repeatedly. The components in the vibrating device 10c not illustrated in FIG. 7 are the same as those in the vibrating device 10 illustrated in FIG. 1.

As illustrated in FIG. 7, a vibrator 3b is tubular. The vibrator 3b includes a first tube portion 31 that is in contact with the outermost-layer lens 1, a second tube portion 32 at which the piezoelectric device 5 is disposed, and a spring portion 33a that connects the first tube portion 31 and the second tube portion 32 to each other. The first tube portion 31, the second tube portion 32, and the spring portion 33a may be formed integrally with or separately from one another.

The spring portion 33a forms a side surface portion of the vibrator 3b, and includes multiple grooves 30 with a lying Y shape (tuning fork shape) equidistantly arranged in the circumferential direction of the vibrator 3b. The grooves 30 extend through the spring portion 33a, and are openings that extend through in the radial direction of the vibrator 3b.

The grooves 30 have a lying Y shape (tuning fork shape) that has line symmetry with respect to the radial direction of the vibrator 3b. Each of the grooves 30 has a first end portion in contact with the first tube portion 31, and a second end portion in contact with the second tube portion 32. The spring portion 33a includes multiple U-shaped posts 35 left after the grooves 30 are formed and connecting the first tube portion 31 and the second tube portion 32 to each other. These posts 35 function as springs to vibrate the outermost-layer lens 1 in the Z-direction.

The posts 35 have a lying U shape. As illustrated in FIG. 7, each post 35 has a connection portion connected to the first tube portion 31 and a connection portion connected to the second tube portion 32, and the connection portions are disposed substantially on a straight line. The vibrator 3b can thus vibrate the outermost-layer lens 1 in the Z-direction by contracting or expanding the U-shaped portions of the posts 35 with the vibrations of the piezoelectric device 5.

As illustrated in FIG. 7, the vibrating device 10c further includes a weight 4 at the first tube portion 31 as an unbalancing member. The weight 4 is disposed only partially instead of around the entire circumference of the first tube portion 31, and has a semicircular shape that extends around half the circumference of the first tube portion 31. The vibrating device 10c thus tilts and vibrates the outermost-layer lens 1 while raising or lowering the side on which the weight 4 is not disposed more than the side on which the weight 4 is disposed. When vibrating the outermost-layer lens 1 while tilting the outermost-layer lens 1, the vibrating device 10c can remove the adhering foreign matter by allowing the foreign matter to slide off the outermost-layer lens 1.

The unbalancing member included in the vibrating device 10c may be a cut portion. The structure of the vibrator 3b illustrated in FIG. 7 is a mere example, and the vibrator may have any structure capable of vibrating the outermost-layer lens 1 in the Z-direction.

### Other Modifications

Any of the components in the vibrating devices according to the embodiments described above, and any of the components in the vibrating devices according to the modification examples described above may be combined as appropriate. In addition, an unbalancing member may generate unbalanced vibrations of the outermost-layer lens 1 by a method other than a method of using a weight or a cut portion (for example, by forming the vibrator 3 from different materials at different locations, by changing the thickness of a portion of the spring portion 33 with a curved cross section (for example, S-shaped cross section), or by applying different voltages to different areas of the piezoelectric device 5). The above-described image pickup device according to one or more embodiments may be, for example, a camera, a laser infrared radar (LiDAR), or a radar. Alternatively, multiple image pickup devices may be arranged.

The above-described image pickup device according to one or more embodiments is not limited to an image pickup device installed on a vehicle, and may be similarly applicable to any image pickup device that includes an optical device and an image pickup element disposed with a light-transparent body in a direction of a field of view and that involves removal of foreign matter on the light-transparent body.

The embodiments disclosed herein are intended in all respects to be illustrative rather than restrictive. The scope of the present disclosure is defined by the scope of claims, not by the above description, and is intended to include the scope equivalent to the scope of claims and all the changes within the scope.

### REFERENCE SIGNS LIST

1 outermost-layer lens
2 housing
2a first portion
2b end portion
2c second portion
2d third portion
2e, 4 weight
3, 3a, 3b vibrator
5 piezoelectric device
6 image pickup element
8 bracket
10, 10a to 10c vibrating device
20 sensor device
21 retainer
30 groove
31 first tube portion
31a cut portion
32 second tube portion
33, 33a spring portion
35 post
100, 100a image pickup device

1. A vibrating device, comprising:
a light-transparent body;
a tubular vibrator in contact with the light-transparent body and constructed to vibrate the light-transparent body, the tubular vibrator including:
a first tube portion that is in contact with the light-transparent body,
a second tube portion,
a spring portion that connects the first tube portion and the second tube portion to each other and that has a curved cross-sectional shape in a plane parallel to the axial direction of the tubular shape, and
an unbalancing member that generates unbalanced vibrations of the light-transparent body;
a piezoelectric device connected to the second tube portion of the vibrator; and
a housing that holds the light-transparent body and that covers the vibrator.

2. The vibrating device according to claim 1, wherein the unbalancing member is a cut portion that deletes a mass from at least a part of the vibrator in at least one of the first tube portion, the second tube portion, or the spring portion.

3. The vibrating device according to claim 1, wherein the unbalancing member is a weight that adds a mass to a part of at least one of the first tube portion, the second tube portion, or the spring portion.

4. The vibrating device according to claim 3, wherein the weight is added to at least the first tube portion.

5. The vibrating device according to claim 4, wherein the weight has a semicircular shape that extends around half a circumference of the first tube portion.

6. The vibrating device according to claim 3, wherein the weight has a semicircular shape that extends around half a circumference of the first tube portion.

7. The vibrating device according to claim 3, wherein the weight has a shape that extends only partially around a circumference of the vibrator.

8. The vibrating device according to claim 3, wherein a material of the weight has a larger specific gravity than a material of the vibrator.

9. The vibrating device according to claim 3, wherein the weight is integral with the vibrator.

10. The vibrating device according to claim 1, wherein the spring portion has an S-shaped cross section.

11. The vibrating device according to claim 1, wherein the spring portion has a shape protruding in a radial direction of the first tube portion with respect to the first tube portion.

12. The vibrating device according to claim 1, wherein the second tube portion has a radially extending portion, and the piezoelectric device is disposed at the radially extending portion.

13. The vibrating device according to claim 1,
wherein the housing is tubular, and includes:
a first portion that holds the light-transparent body,
a second portion that has a larger diameter than the first portion, and
a third portion that extends in a radial direction of the first portion and that connects the first portion and the second portion to each other.

14. The vibrating device according to claim 13, wherein the first portion has a shape extending in an axial direction of the housing.

15. The vibrating device according to claim 13, wherein the third portion has a weight at a surface thereof facing the vibrator.

16. An image pickup device, comprising:
the vibrating device according to claim 1; and
an image pickup element disposed in a direction of a field of view with the light-transparent body.
